(19) United States
(12) Patent Application Publication
(10) Pub. No.: US 2010/0296138 A1
(43) Pub. Date: Nov. 25, 2010

(54) APPARATUS FOR DETECTING THE CONTENT OF A BOOK

(75) Inventors: Alfred Jakes, Wien (AT); Vitus Boesch, Wien (AT); Sofie Quidenus, Wien (AT)

Correspondence Address: DESIGN IP, P.C., 5100 W. TILGHMAN STREET, SUITE 205, ALLENTOWN, PA, 18104, US

(73) Assignee: QUIDENUS GMBH, Wien (AT)

(21) Appl. No.: 12/678,415

(22) PCT Filed: Sep. 16, 2008
(86) PCT No.: PCT/AT08/00334

§ 371 Date: Mar. 16, 2010

(30) Foreign Application Priority Data
Sep. 17, 2007 (AT) A 1451/2007

(51) Int. Cl. H04N 1/04

(52) U.S. Cl. 358/494; 348/E07.085

(57) ABSTRACT

In a device for detecting the contents of a book or of sheets bound in the manner of a book, with a cradle with two support surfaces arranged next to each other at an obtuse angle, a book can be inserted in the opened state, the book lying facing upwards with the opened pages. The relative positions of the support surfaces in relation to one another can be set, namely, at least in a direction that is parallel to the plane of the support surface and at right angles to the bifurcation. In addition, the device has a camera system with at least two camera units, which are each positioned above the cradle for recording one of the opened pages of a book being held in the cradle, and a page-turning device for turning the pages of a book being held in the cradle, wherein the cradle or the support surface can be moved in relation to the camera system in an essentially vertical position.

The present invention pertains to a device for detecting the contents of a book or sheets bound in the manner of a book, comprising at least: a cradle with two support surfaces, which are arranged next to each other at an obtuse angle in relation to one another and into which a book can be placed in the opened state, wherein the book is lying with the opened pages facing upwards; a camera system with at least two camera units, which are each positioned above the cradle for recording one of the opened pages of a book being held in the cradle; as well as a page-turning device for turning the pages of a book being held in the cradle; wherein the cradle and/or the support surfaces is/are movable in relation to the camera system in an essentially vertical position.

Devices for detecting books, especially by means of a camera for subsequent digitization, are well known.

WO 2005/088957 A1 shows a process and a device for imaging a two-dimensional object, e.g., a book, especially for the digital detection of the book. A cradle, into which the book can be placed, is opened at an acute angle. Two cameras are arranged symmetrically above the book. A wedge-shaped unit comprising two glass panes is pressed onto the book during the recording of the images for smoothing the pages; this unit is lifted for turning the pages.

WO 2006/105568 A1 additionally describes that a wedge-shaped recording unit can be moved towards the book and away from same and the cradle can be moved at right angles thereto as an angular supporting device, on which the book lies. The recording unit also ensures the turning of the pages and is equipped with an air suction system for this. However, the air suction system has the drawback that the surface of the sheet drags along the glass pane and is thus subjected to a less gentle operation.

The problems that may occur with the changing dynamic conditions during the page-turning operation are ignored in both said documents.

Books have various types of binding, consist of a great variety of grades of paper (or paper-like materials) and therefore possess greatly varying properties. One of the essential properties of the book, which are important for automatic page-turning, is the clinging effect of the book. The clinging effect is due to the stored elastic energy of the book. This energy depends on a great variety of factors and also causes the closing of individual pages or even of the entire book.

The clamping effect of the book determines the extent to which a book can be opened and is allowed to be opened. There are types of binding that make it possible to open the book by 180° without any problem. Many books, e.g., textbooks, have been found such that they can stay “comfortably” lying on a straight surface without the sheets folding together. In general, each book has an “ergonomic” opening angle of its own.

However, the optimal opening angle of the book also has a lot to do with how far the contents (printed or written part) are made visible. In many cases, there is print or writing over the center of the book. To make this area readable, the book should be opened completely (180°); however, this is often not possible because opening to 180° cannot be performed without possible damage to the back of the book as a result because of the bookbinding and the aging of the book.

A device for lifting a sheet to turn it over is shown in WO 2006/026800 A2. The page-turning operation is initiated by means of a lifting element, which can be pivoted about an axis of rotation extending at an acute angle to the plane of the support surface, and whose tip comes into contact with a corner of the sheet. The sheet is lifted by a rotation of the lifting element.

One object of the present invention is to improve the prior-art devices for detecting books and similar works, wherein especially gentle handling of the book or image on the sheet that is to be recorded is important.

For holding a (thick) book, WO 2004/025410 A2 proposes a cradle arrangement, which has two separate cradle halves, wherein the two wings of the cradle can be moved at right angles to the plane of the wings.

Said object is accomplished on the basis of a device of the type mentioned in the introduction by the support surfaces being adjustable according to the present invention in relation to one another in terms of their relative positions, namely, at least in a direction that is parallel to the plane of the support surface and at right angles to the bifurcation. Bifurcation is defined here as the line along which the two pages of the opened double page or the planes formed by them meet. In a book, the bifurcation corresponds essentially to the bookbinding edge.

Gentle positioning of the book is possible due to this solution, and the state and nature of the book cover, the inner book, the paper grade, etc., can be taken better into account. This makes possible gentle handling especially concerning changing dynamic stresses after each page-turning operation and the correlative dynamic change in bookbinding in the unit formed with the inner book and the book cover, and to take into account the state and position of the picture to be photographed, even if the surface of the book/sheet to be detected is leveled with a glass pane or a clamp system.

The devices from the state of the art usually provide for a rigid and unchangeable position of the book. A prior-art device therefore requires a person who must continually intervene during the page-turning operation. Constant position of the book during the page-turning operation frequently causes dynamic stresses to build up in the area of the binding, which may represent a heavy load for the book and lead to damage.

By contrast, the present invention provides for the possibility of assuming positions and motion processes optimized for certain books during the page-turning operation.

Because of the above-described factors, there is no “one” book opening angle or “one” book positioning in general that makes it possible at the same time to optimally detect the contents and is also gentle for each book. Setting to different opening angles, which reach from 180° to 60°, as well as different alignment of the book covers in relation to one another leads to a globally gentle handling of the books for these reasons.

The pages are detected primarily by photographic recording of the images of the opened double page and storage on a corresponding data processing means; further processing by OCR scan or the like may take place thereafter as needed.

The present invention makes possible the fully automatic page-turning of books and photographic recording of both pages opened at the same time without a flash with coordinated light, with double sheet check as well as transmission to a customer-oriented data processing system. Typical book sizes are, e.g., books of a size of up to 310×230 mm, a thickness of 80 mm, with paper gram-atoms of 50 to 100 g, preferably with book backs that are sized with thread stitching. However, other works bound in a book-like manner, e.g., ring binders, brochures in which the pages can be turned one by one, are possible as well.

Moreover, the present invention makes it possible to change the books rapidly and smoothly and improves the quality of the scan result due to the parameters being set independently from the scanning operation, because different parameters, such as paper grades, paper thicknesses, book thickness, yellowing, are taken into account in advance. The books can be processed separately from the scanning device and deposited for subsequent or later processing. Preparation outside the scanning device additionally distinguishes the present invention from the procedure described in WO 2004/025410 A2.

The device according to the present invention may additionally have a means for smoothing the opened pages, with at least one angular glass pane, which can be positioned against the pages, wherein the angle of the glass pane corresponds to the angle formed by the support surfaces with one another, and wherein the means for smoothing the pages can be lifted off from the book for smoothing the pages during the loading operations as well as during page-turning.

An advantageous variant of the present invention is equipped with a chamber, which surrounds at least the cradle and the page-turning device and in which overpressure can be generated. This prevents contamination and can, besides, remove dust generated during the handling of the book.

In addition, it is favorable to use a page-turning device in which page-turning is initiated mechanically by frictional contact between a moving lifting element and a page, as it is described, for example, in WO 2006/026800 A1.

A storage means belonging to the device may be advantageously set up for storing the images recorded by the camera system, preferably in the digital format.

It is additionally favorable for a more flexible positioning of the book and of the book backs, especially in the course of the detection operation with pages turned differently, if the positions of the support surfaces can be set in three directions independently from one another. It may likewise be advantageous if the support surfaces are additionally adjustable in terms of the angle formed by them.

The present invention will be explained in more detail below on the basis of a nonlimiting exemplary embodiment, which is described in the following description along with the corresponding drawings.

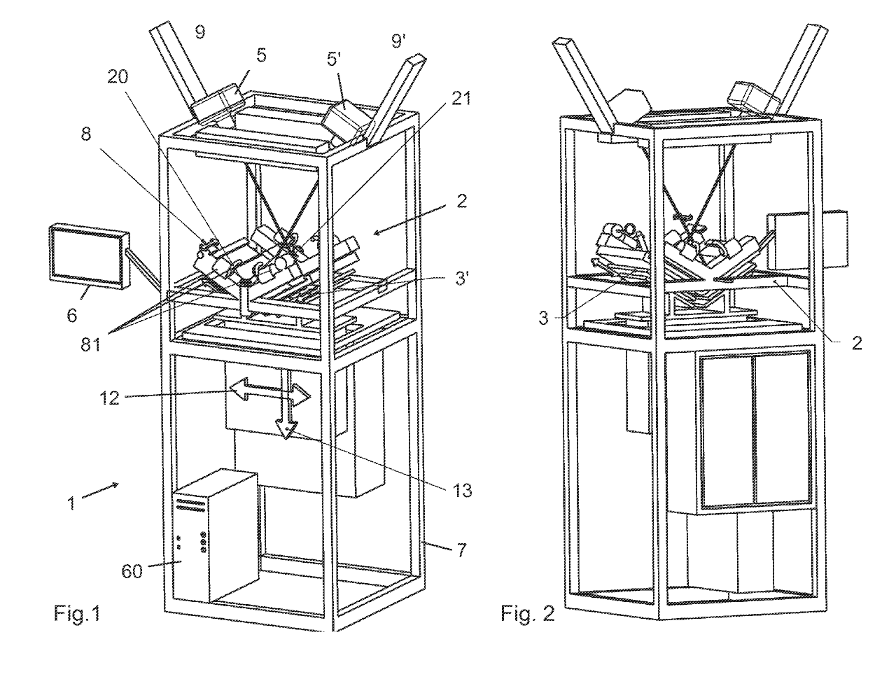

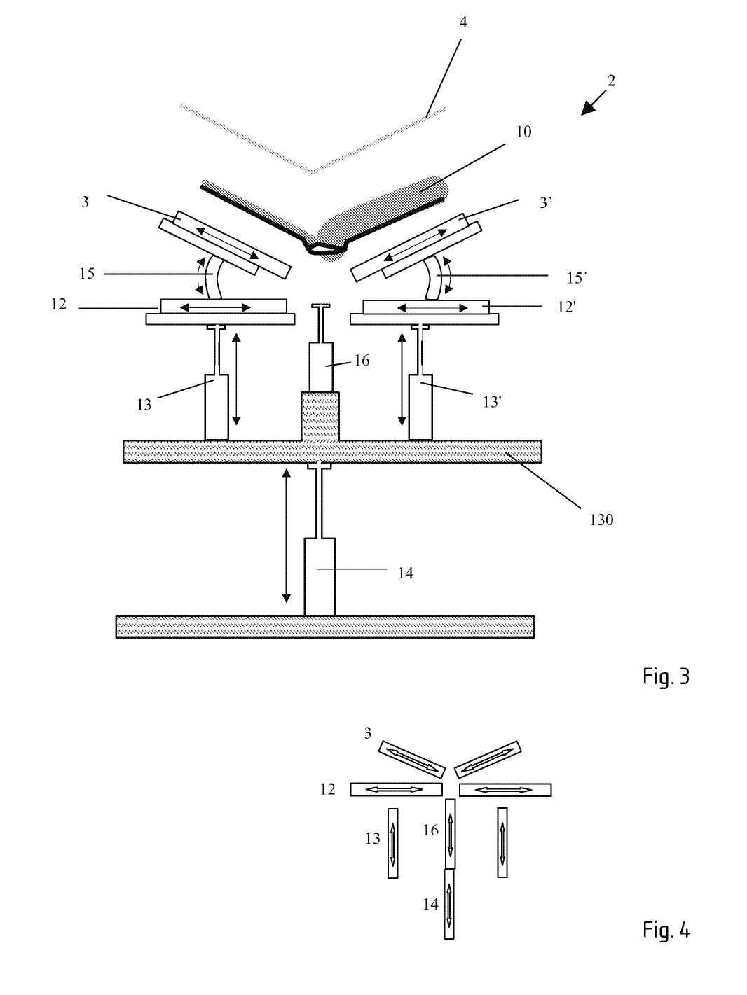

FIGS. 1 and 2 show a scanning means according to the exemplary embodiment in a perspective oblique front view and in a perspective oblique rear view;

FIG. 3 shows the carriage arrangement of the scanning means according to FIGS. 1 and 2;

FIG. 4 illustrates the directions of motion of the carriage arrangement according to FIG. VI;

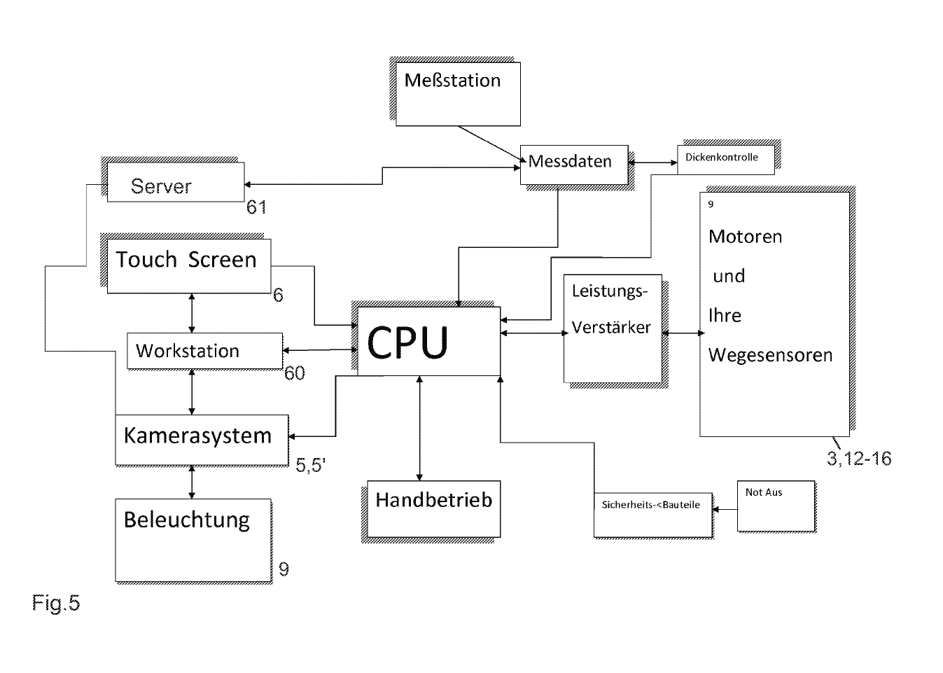

FIG. 5 shows a control diagram for the scanning means according to FIGS. 1 and 2;

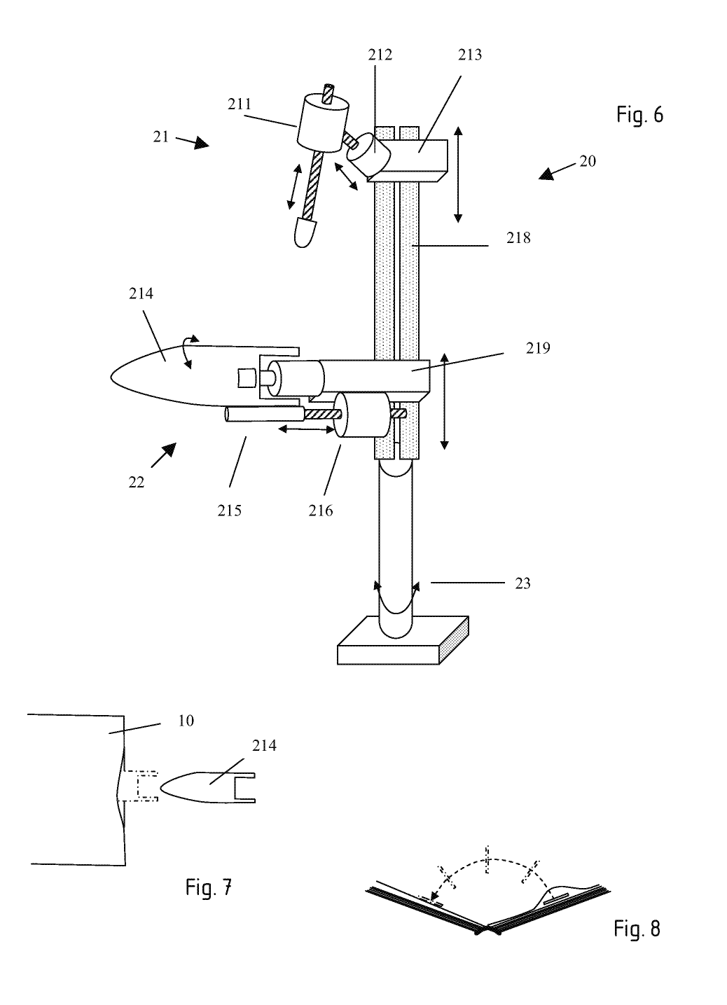

FIG. 6 shows the page-turning device;

FIGS. 7 and 8 illustrate the page-turning operation;

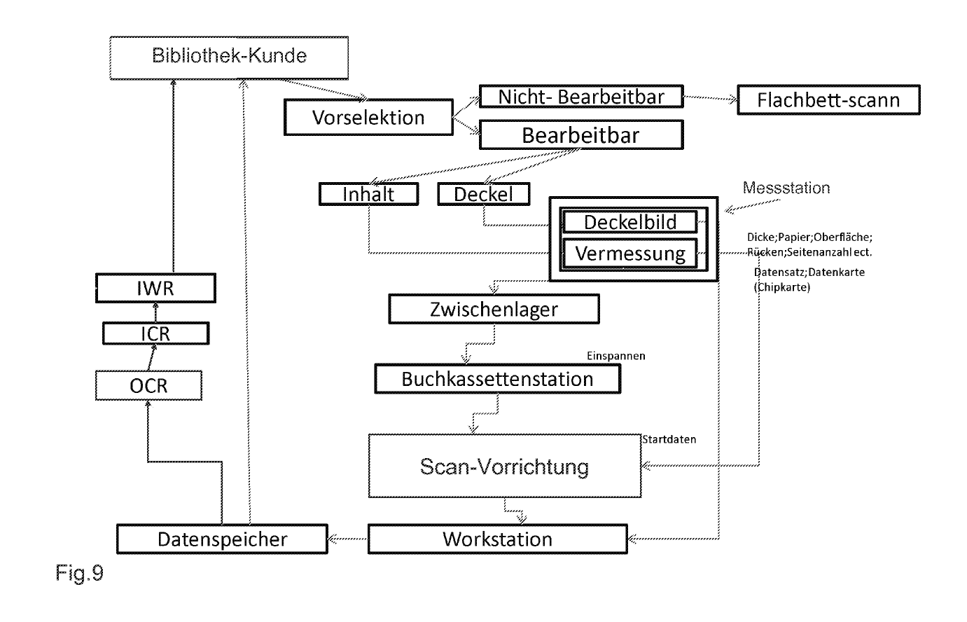

FIG. 9 shows a schematic overview of the entire detection operation, for example, of the books of a library; and

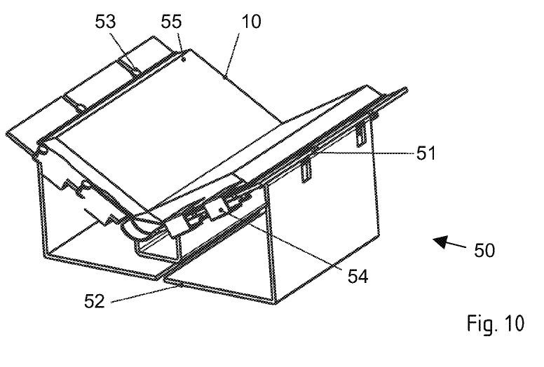

FIG. 10 shows the measuring table for the preparatory measurement of a book.

The exemplary embodiment of a scanning means according to the present invention, which will be described below and is also called “Digitization Center V Solution,” is a device for the simultaneous imaging of two pages of a book. FIG. 1 shows an overall view of the scanning means from the side facing the user (front side). FIG. 2 shows a view from the rear side, and FIG. 3 shows a detail in which the positioning of the book with the carriage arrangement is shown. FIG. 5 shows a corresponding control diagram.

With reference to FIGS. 1 through 3, the book 10 is positioned by means of a movable carriage arrangement 2 in a V position with an opening angle of, e.g., 120° on a “book holder” (cradle), which is formed by two carriages 3, 3′, which offer a support surface each for the book. A glass pane 4 (not shown in FIGS. 1 and 2) arranged in a V-shaped pattern with a corresponding opening angle is lowered onto the top side of the book and photographed by means of two stationarily arranged cameras 5, 5′ per page. The data thus obtained are collected in a workstation 60 operated via a touch screen 6 and can be sent to a server 61 (FIG. 5) as needed. The glass pane 4 is used for the (topmost) pages of the book 10 to be photographed to be aligned smoothly (i.e., flatly) at the glass pane and thus smoothed. Lighting fixtures 9, 9′ are located next to the cameras 5, 5′. A chamber 7, in which overpressure can be generated, surrounds the entire device including the carriage arrangement 2.

The means according to the present invention uses a cassette system, into which a book with plates attached thereto is inserted. Each book cover is connected to the plate by means of cover clamps 81 and is set up with four cover fixing pins displaceable in a spring-tensioned manner.

The process uses two stationarily arranged cameras 5, 5′ with permanently preset distance from the plane of projection. The plane of projection for the scanning operation comprises a glass pane 4 in case of unproblematic books; a device formed from a stainless steel frame, which are pressed onto the pages at the margin of the page only during the upward motion of book 10, may be used, instead, in case of delicate books.

Two plates, which are not connected to one another, are now clamped onto the book covers by means of chromium-plated, spring-tensioned bars 81, brought into position by spring-tensioned bolts on the plate and this is then inserted into the book holder of the means. In one variant, the book may also be placed on loosely. In another variant, the right-hand book cover can be first connected to the carriage and after the pages have been turned over in half of the book, the left-hand book cover is connected to the slide; as a result, the respective other half of the book nestles freely and loosely against the glass pane. The opening angle of the book holder preferably equals 120° during the phase of page-turning, but it may also be between 100° and 135° and possibly even 137° (angle of golden section) depending on the type and nature of the book.

With reference to FIGS. 3 and 4, the two support surfaces or carriages 3, 3′ can be displaced in three planes: Horizontally towards each other or away from one another, vertically and in the plane of the support surface. The displacement in the direction of the plane of the plate makes possible a more accurate application of the data obtained from the measuring station concerning the accurate adjustment of the bifurcation in relation to the axis of symmetry of the glass pane. Besides the two carriages 3, 3′ mentioned, the carriage arrangement 2 has, in addition, a left and right horizontal carriage 12, 12′ each as well as a left and right vertically moving carriage 13, 13′ each for these motions. In addition to—or also instead of—the two vertical moving carriages, an actuator 14 may also be provided for a central lift, which adjusts, e.g., the baseplate 130 of the vertically moving carriage. The angle of the connection pieces 15, 15′ between the inclined support carriages 3, 3′ and the horizontal carriages 12, 12′ can be adjusted when needed. In addition, an adjustable back support 15 may be provided, which additionally supports the book in the area of the back.

With reference to FIGS. 6 through 8, the page is changed automatically by means of a page-turning means 20. The sheet is pushed up at one corner (lifted) by means of a finger drive 21, and the sheet is turned from right to left with a page-turning arm 22. The lateral and height offset inevitably occurring during page-turning is corrected or set by the book holder being adjustable in three planes and the carriage arrangement 2.

The scanning means curls up the page with a finger drive 21, which is known per se. Fixing blocks, which hold down the sheet during the scanning operation, now open and the page-turning arm 22 can turn the sheet. A double sheet check is performed by means of an ultrasound system (not shown). The clamp is again closed after turning the page and the glass pane is lowered onto the scan plane of the book surface. A scanning operation takes about 3 to 4 seconds, so that about 30 to 40 pages can be processed or photographed per minute.

FIG. 6 shows the page-turning means 20. Finger drive 21 is already known per se from WO 2006/026800 A2. Contrary to that document, two linear drives 211, 212 are provided here, the first linear drive 211 moving the finger forward and bringing about a rotation in the process and the second linear drive 212 additionally bringing about a change in the height of the finger. The finger holder 213 is additionally adjustable along a guide 218. Finger drive 21 and page-turning arm 22 are rotatable together about an axis 23. Page-turning arm 22 has a blade 214, which is responsible for turning the sheet. The blade 214 is fastened by means of a mounting block 219 and is rotatable about an axis 215, and is linearly movable by means of a drive 216. As can be recognized in FIG. 7, the blade 214 moves by a linear motion under the sheet lifted by the finger drive 21 and then performs a rotary motion, which turns the page over, as is shown in FIG. 8.

The operation of detecting one or more books will be described below. The detection of books is divided into two main steps, namely, a preparation of the book called preselection here including the entry of bibliographic data, as well as the detection (digitization) of the individual pages of the book or double pages of the book proper. An entire detection operation is shown synoptically in FIG. 9.

### Preselection

When preselecting the books, the following parameters are determined for the books to be detected:
1. Books are measured. Overall length×width×height
2. Length×width×height of the pages without cover
3. The number of pages and number of scans are determined.
4. The thickness of the sheet is determined.
5. The type of bookbinding (book back) is determined.
6. The weight of the sheet is determined.
7. The surface roughness is determined.
8. Yellowing is analyzed.
9. Discoloration due to chemical processes is analyzed.
10. Ink corrosion is established and analyzed.
11. The type of printing is determined.
12. The flexibility of the paper grade is determined.
13. The pH value is determined.
14. The resistance to tearing of the sheet is determined.
15. Mechanical problems are identified.

The books are sorted to categories according to the above-mentioned properties.

With reference to FIG. 10, the book-specific parameters such as thickness of the book, of the paper, surface properties, type of back, number of pages in the respective book, are determined in a measuring station 50; these are processed further electronically by means of algorithms and stored on a storage medium (on the book cassette). The information determined is sent with the book cassette into the scanning device. The data determined at the measuring station make it possible during the scanning operation to set up the bifurcation accurately, to control the lighting means and to set the camera settings. The measuring station 50 has, for example, an angular fixing plate 51, which is arranged on a measuring table 52. The book is fastened by means of fixing points 53 and clamps 54 and the dimensions are determined. In addition, compression springs 55 may be provided, which hold the pages of the book.

These data are stored in the computer and on a storage medium at the cassette. The meta data of the book are entered.

The book cover, book back and, for reasons that can be attributed to the type of bookbinding, unmanageable pages at the beginning of the book are scanned on a separate scanner.

### Digitization

At the beginning of digitization, two plates, which are not connected to one another, are clamped on the book by means of chromium-plated, spring-tension bars, and these plates are pushed into position by means of spring-tension bolts on the plate. Positioned by bolts, the book is then inserted with the plates into the book holder. The scanning operation can then begin page by page:
1. The book holder moves, controlled by a program, by means of motor-driven carriages. The positioning takes place, beginning with the first double page, by means of a laterally moving carriage, vertically moving carriages as well as a cover carriage each (left and right book covers);
2. Page-turning operation, for example, according to WO 2006/026800 A2; a finger pushes up the sheet—page-turning arm pushes sheet from right to left
3. Double sheet checking by means of ultrasound
4. All clamps closed or glass pane in position
5. Two photographic cameras photograph one page each and send the data on to the server
6. Book holder corrects the lateral and vertical offset and adjusts itself correspondingly into the next (double) page position

### Technical Specifications (Example)

### Main Components

1. Basic structure (frame)
2. Book holder
3. Camera system
4. Lighting
5. Workstation
6. Adjusting station/measuring station, cassette
7. Page-turning components
8. Control units
Base with the doors closed width×length 0.88×0.95 m
Height of device 1.8 m
Folding doors opened 1.8 m×1 m
Control panel length×width×height 0.4 m×0.4 m×0.9 m to 1.6 m, variable
Weight approx. 220 kg depending on accessories
Book insertion height 1.2 mm, variable
Electric connection 220 V/16 A (110 V/16 A)
Pages per hour>2,000 depending on design and condition of book
Speeds freely controllable via touch screen control panel
Standard book format 320 mm×225 mm to 150 mm×170 mm
Oversizes and undersized formats option

No set-up times because preparation is performed by the book plate system by means of measuring book holder

As well as RIFF cards, data transfer for book-save and archiving system

### Features of Page-Turning Device

A with clamping finger system, so that the printed part is not stressed

B with glass pane system

C Patented linear or rotation finger

D Adjustable page-turner drive

Double sheet checking by means of ultrasound

### Features of Camera System—Industrial Camera

Resolution selectable, typically corresponding to 300 dpi on the book page

Lighting system LED-5600k

### Features of Data Bank

Feature: electronic data processing system

1. A device for detecting the contents of a book or sheets bound in the manner of a book, comprising:
a cradle with two support surfaces, which are arranged next to each other at an obtuse angle and into which a book can be inserted in the opened state, wherein the book lies with the opened pages facing upwards;
a camera system with at least two camera units, which are positioned above the cradle for recording one of the opened pages of a book being held in the cradle; and
a page-turning device for turning the pages of a book being held in the cradle; wherein the cradle and/or the support surfaces can be moved relative to the camera system in an essentially vertical position,
characterized in that
the relative positions of the support surfaces in relation to one another can be set, namely, at least in a direction that is parallel to the plane of the support surface and at right angles to the bifurcation.

2. The device in accordance with claim 1, characterized by a means for smoothing the opened pages, having at least one angular glass pane, which can be positioned against the pages, wherein the angle of the glass pane corresponds to the angle of the support surfaces in relation to one another, and wherein the means for smoothing the pages can be lifted off from the book during the loading operations as well as during page-turning.

3. The device in accordance with claim 1, characterized by a chamber, which surrounds at least the cradle and the page-turning device and in which overpressure can be generated.

4. The device in accordance with claim 1, characterized by a page-turning device, in which page-turning is initiated mechanically by frictional contact between a moving lifting element and a page.

5. The device in accordance with claim 1, characterized by a corresponding storage means for storing the images recorded by the camera system, preferably in the digital format.

6. The device in accordance with claim 1, characterized in that the positions of the support surfaces can be set in three directions independently from one another.

7. The device in accordance with claim 1, characterized in that the angles formed by the support surfaces can be additionally set.

8. The device in accordance with claim 2, characterized by a chamber, which surrounds at least the cradle and the page-turning device and in which overpressure can be generated.

9. The device in accordance with claim 2, characterized by a page-turning device, in which page-turning is initiated mechanically by frictional contact between a moving lifting element and a page.

10. The device in accordance with claim 3, characterized by a page-turning device, in which page-turning is initiated mechanically by frictional contact between a moving lifting element and a page.

11. The device in accordance with claim 2, characterized by a corresponding storage means for storing the images recorded by the camera system, preferably in the digital format.

12. The device in accordance with claim 3, characterized by a corresponding storage means for storing the images recorded by the camera system, preferably in the digital format.

13. The device in accordance with claim 4, characterized by a corresponding storage means for storing the images recorded by the camera system, preferably in the digital format.

14. The device in accordance with claim 2, characterized in that the positions of the support surfaces can be set in three directions independently from one another.

15. The device in accordance with claim 3, characterized in that the positions of the support surfaces can be set in three directions independently from one another.

16. The device in accordance with claim 4, characterized in that the positions of the support surfaces can be set in three directions independently from one another.

17. The device in accordance with claim 5, characterized in that the positions of the support surfaces can be set in three directions independently from one another.

18. The device in accordance with claim 2, characterized in that the angles formed by the support surfaces can be additionally set.

19. The device in accordance with claim 3, characterized in that the angles formed by the support surfaces can be additionally set.

20. The device in accordance with claim 4, characterized in that the angles formed by the support surfaces can be additionally set.
